(19) United States
(12) Patent Application Publication
(10) Pub. No.: US 2025/0322774 A1
(43) Pub. Date: Oct. 16, 2025

(54) REARVIEW MIRROR PROJECTION DEVICE PROVIDING ADVERTISING PERFORMANCE ON CAR BODY

(71) Applicant: Shen-Huai Hsu, Tainan City (TW)

(72) Inventor: Shen-Huai Hsu, Tainan City (TW)

(21) Appl. No.: 18/784,925

(22) Filed: Jul. 26, 2024

(30) Foreign Application Priority Data
Apr. 10, 2024 (TW) 113203495

(51) Int. Cl. G09F 21/04; B60R 1/06; G09F 19/18

(52) U.S. Cl. CPC G09F 21/04; B60R 1/06; G09F 19/18

(57) ABSTRACT

A rearview mirror projection device includes a rearview mirror housing, a micro projection host, and a projection lens. The rearview mirror housing is secured on and covers a rearview mirror of a car. The rearview mirror housing has an outside having a lower edge provided with a circular hole. The micro projection host is mounted in the car. The micro projection host is connected with a host of the car. The micro projection host is provided with an electric wire electrically connected with the projection lens. The projection lens is mounted in the circular hole of the rearview mirror housing. The projection lens has an adjustable angle and projects an image or a picture toward an outside of a car body of the car.

### BACKGROUND OF THE INVENTION

### Field of the Invention

The present invention relates to a projector and, more particularly, to a projection device mounted on a rearview mirror of a car.

### Description of the Related Art

An advertisement or commercial is placed on the car body of a car to provide an advertising performance for products. Thus, when the car is moving on the road, the advertisement on the body of the vehicle provides an eye-catching effect, thereby causing an visual attraction efficiently. In such a manner, the car body advertising can easily spread commercial information to the consumer public. Generally, the car body advertisements are presented in the form of body painting to facilitate identification of the consumers. However, these advertisements need to be printed on stickers with pictures and are then stuck to the doors on both sides of the car body, so that installation of the car body advertisements is not easy and has a higher cost. In addition, the screen of the car body advertisement is changed or replaced during a period of time after the advertising sticker is adhered to the car body, so that the user cannot change or replace the car body advertisement. Further, the car body advertisement only provides a single content with a static screen in the form of figures or characters, thereby decreasing the advertising effect.

### BRIEF SUMMARY OF THE INVENTION

The primary objective of the present invention is to provide a rearview mirror projection device that produces an advertising performance on a car body.

In accordance with the present invention, there is provided a rearview mirror projection device comprising a rearview mirror housing, a micro projection host, and a projection lens. The rearview mirror housing is secured on and covers a rearview mirror of a car. The rearview mirror housing has an outside having a lower edge provided with a circular hole. The micro projection host is mounted in the car. The micro projection host is connected with a host of the car. The micro projection host is provided with an electric wire electrically connected with the projection lens. The projection lens is mounted in the circular hole of the rearview mirror housing. The projection lens has an adjustable angle and projects an image or a picture toward an outside of a car body of the car.

According to the primary advantages of the present invention, the projection lens is mounted on the rearview mirror of the car to project and display the advertising picture on the car body of the car in a static or dynamic manner, thereby enhancing the versatility of the rearview mirror projection device.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a rearview mirror projection device in accordance with the preferred embodiment of the present invention.

FIG. 2 is a perspective view of the rearview mirror projection device in accordance with the preferred embodiment of the present invention.

FIG. 3 is an exploded perspective view showing the rearview mirror projection device is to be mounted on a car.

FIG. 4 is a schematic perspective view showing the rearview mirror projection device is mounted on the car to project light beams on a front door of the car.

FIG. 5 is a schematic perspective view showing the rearview mirror projection device is mounted on the car to project light beams on a front door and a rear door of the car.

FIG. 6 is a schematic perspective view showing the rearview mirror projection device is mounted on the car to project an advertising image in a dynamic manner.

### DETAILED DESCRIPTION OF THE INVENTION

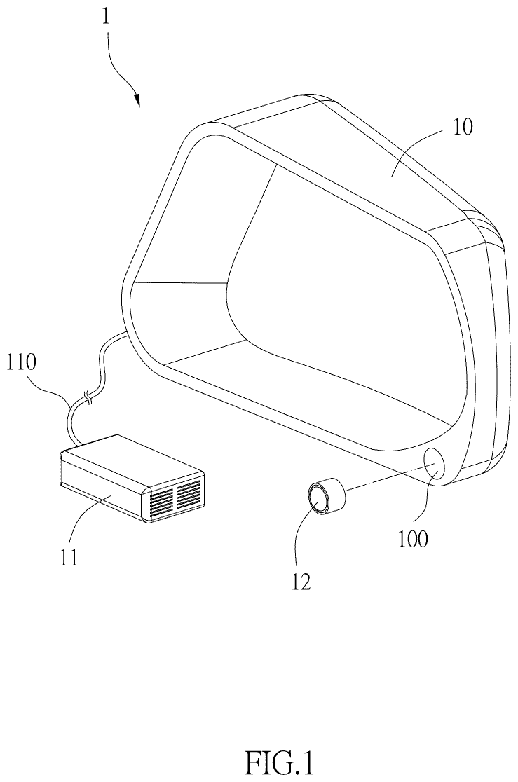

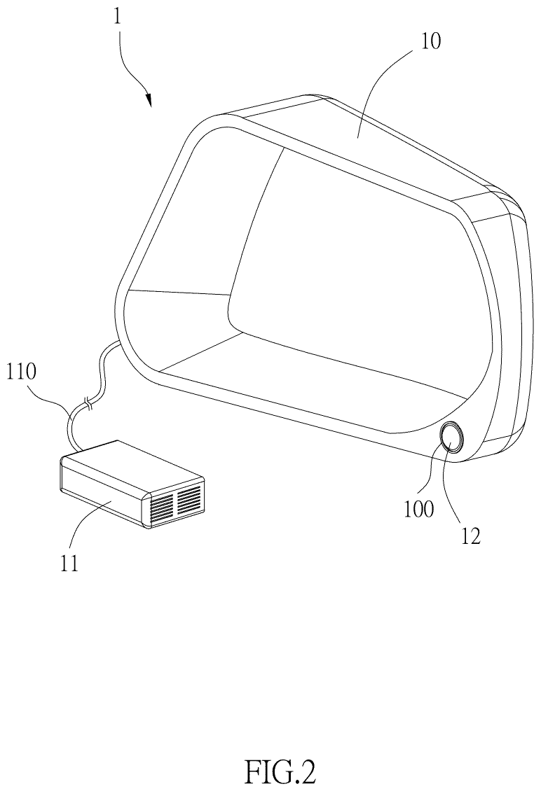

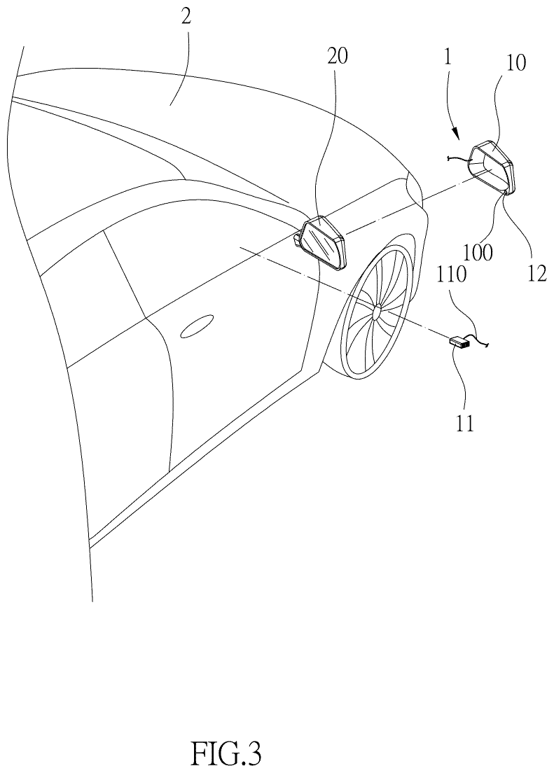

Referring to the drawings and initially to FIGS. 1-3, a rearview mirror projection device 1 in accordance with the preferred embodiment of the present invention comprises a rearview mirror housing (or casing or shell) 10, a micro projection host 11, and a projection lens 12.

The rearview mirror housing 10 is secured on and covers a rearview mirror 20 of a car 2. The rearview mirror housing 10 has an outside having a lower edge provided with a circular hole 100.

The micro projection host 11 has a high-definition projecting system. The micro projection host 11 is mounted in the car 2. The micro projection host 11 is connected with a host of the car 2. The micro projection host 11 is provided with an electric wire (or cord) 110 electrically connected with the projection lens 12.

The projection lens 12 is mounted in the circular hole 100 of the rearview mirror housing 10. The projection lens 12 has a cylindrical shape. The projection lens 12 has an adjustable angle and projects an image or a picture toward an outside of a car body of the car 2. Preferably, the image or picture can be recorded previously.

In the preferred embodiment of the present invention, the micro projection host 11 is connected with the host of the car 2 through Bluetooth or WIFI.

In the preferred embodiment of the present invention, the micro projection host 11 is connected with the host of the car 2 through a wireless or wire connection.

In the preferred embodiment of the present invention, the micro projection host 11 projects a static picture (or screen) or a dynamic picture (or screen) on a door of the car 2. Preferably, the static picture includes characters, figures or the like, and the dynamic picture includes a film or the like.

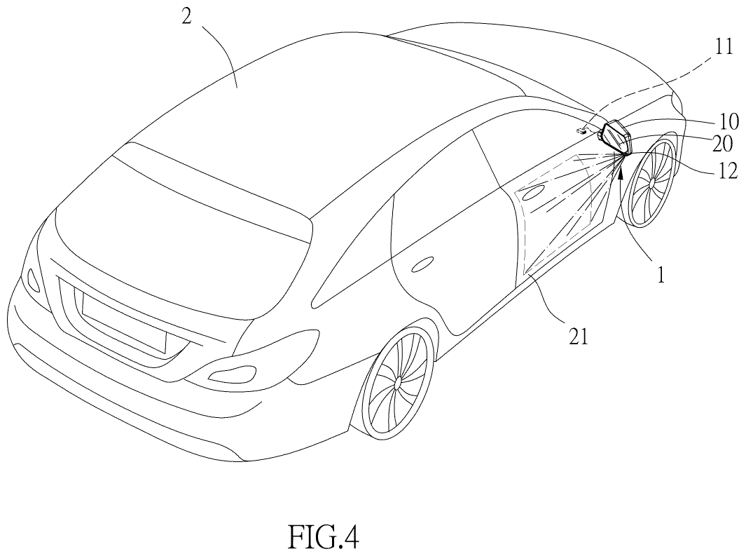

In use, referring to FIG. 4 with reference to FIGS. 1-3, after the angle of the projection lens 12 is adjusted, the projection lens 12 projects an image or a picture onto the front door 21 of the car 2.

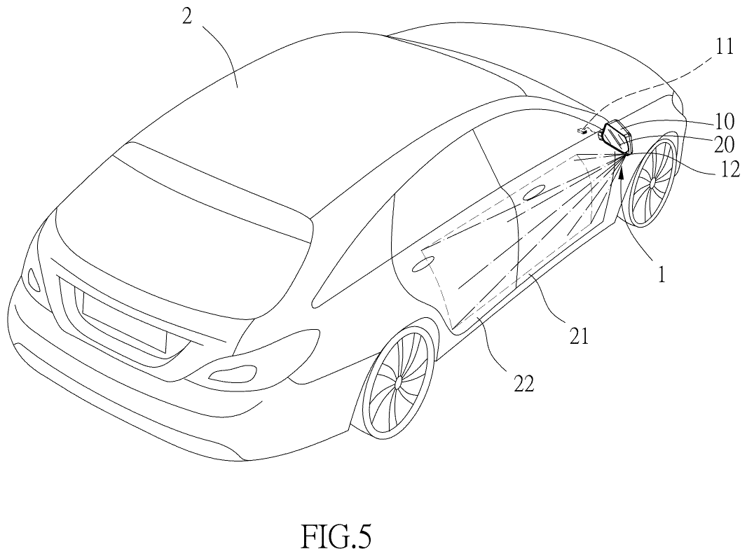

Alternatively, referring to FIG. 5 with reference to FIGS. 1-3, after the angle of the projection lens 12 is adjusted, the projection lens 12 projects an image or a picture onto the front door 21 and the rear door 22 of the car 2.

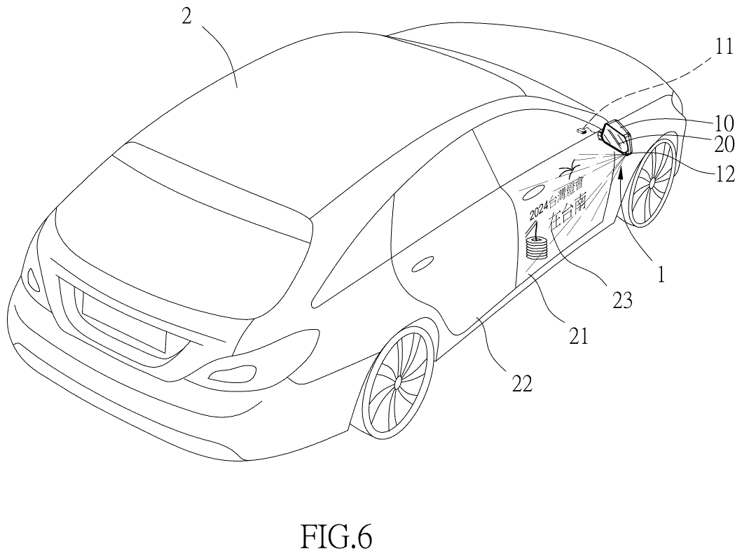

Referring now to FIG. 6 with reference to FIGS. 1-3, after the micro projection host 11 is connected with the host (not shown) of the car 2 through Bluetooth or WIFI, the micro projection host 11 is operated and controlled by the driver in the car 2, to manipulate the projection lens 12, so that the projection lens 12 projects an advertising image 23 onto the car body of the car 2, such as the front door 21 or the rear door 22, to present the advertising image 23 to the consumer public or other drivers and passengers on the road.

Accordingly, the projection lens 12 is mounted on the rearview mirror 20 of the car 2 to project and display the advertising picture on the car body of the car 2 in a static or dynamic manner, thereby enhancing the versatility of the rearview mirror projection device 1. In addition, the advertising content can be changed and replaced at any time by the driver in the car 2 to facilitate the driver using and operating the rearview mirror projection device 1. Further, the advertising image 23 presents a dynamic mode to display richer advertising contents, thereby enhancing the commercial competitiveness. Further, the angle of the projection lens 12 is adjusted to the optimum, so that the commercial picture is projected to a desired position of the car 2, thereby enhancing the aesthetic quality of the commercial picture.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A rearview mirror projection device comprising:
a rearview mirror housing, a micro projection host, and a projection lens;
wherein:
the rearview mirror housing is secured on and covers a rearview mirror of a car;
the rearview mirror housing has an outside having a lower edge provided with a circular hole;
the micro projection host is mounted in the car;
the micro projection host is connected with a host of the car;
the micro projection host is provided with an electric wire electrically connected with the projection lens;
the projection lens is mounted in the circular hole of the rearview mirror housing; and
the projection lens has an adjustable angle and projects an image or a picture toward an outside of a car body of the car.

2. The rearview mirror projection device as claimed in claim 1, wherein the micro projection host is connected with the host of the car through Bluetooth or WIFI.

3. The rearview mirror projection device as claimed in claim 1, wherein the micro projection host is connected with the host of the car through a wireless or wire connection.

4. The rearview mirror projection device as claimed in claim 1, wherein the micro projection host projects a static picture or a dynamic picture on a door of the car.

5. The rearview mirror projection device as claimed in claim 4, wherein the static picture includes characters or figures, and the dynamic picture includes a film.
